(19) United States
(12) Patent Application Publication
(10) Pub. No.: US 2006/0290980 A1
(43) Pub. Date: Dec. 28, 2006

(54) Character entry system

(75) Inventor: Masahiro Terada, Asaka-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/471,633

(22) Filed: Jun. 21, 2006

(30) Foreign Application Priority Data
Jun. 22, 2005 (JP) 181864/2005

(51) Int. Cl. G06F 3/12

(52) U.S. Cl. 358/1.15

(57) ABSTRACT

A system that allows everyone to readily enter a desired character into a machine with a limited character entry capability, such as a shop front printing service machine and the like. The system includes, for example, a shop front printing service machine, a cell phone, and a character entry server, which are connected with each other via the Internet. A character is entered into the cell phone by the user, which is transmitted to the shop front printing service machine through the character entry server, and received by the shop front printing service machine.

### BACKGROUND OF THE INVENTION

1. Field of the Invention

The present invention relates generally to a character entry system. More specifically, the present invention relates to a character entry system in which a character is entered using, in particular, a portable terminal, such as a cell phone or the like.

2. Description of the Related Art

Users of digital cameras may place orders for printing digital images obtained by the cameras through, for example, a shop front printing service machine installed at the front of a photo shop for accepting printing orders. Here, the shop front printing service machine is capable of attaching characters of comment or the like to the images, as well as printing images. In order to attach characters to the images, the users need to enter the characters into the shop front printing service machine. Therefore, the shop front printing service machine includes a character entry means, such as a touch panel or a key board, for use by the user for entering characters.

Further, a method for entering handwritten characters into such shop front printing service machine is proposed as described, for example, in Japanese Unexamined Patent Publication No. 2000-332991, in which the handwritten characters are automatically recognized by a scanner and the recognized characters are attached to the printed image.

It is, however, a troublesome chore to select and enter alphabets or Japanese syllables one at a time using a touch panel on the display screen of a monitor or the like of the shop front printing service machine. Kana-kanji conversion of Japanese language is particularly troublesome, and hence it is difficult for inexperienced users to use a keyboard for this purpose. Further, provision of a keyboard requires a space on the operation panel of the shop front printing service machine. The limited space on operation panel for arranging keys inevitably requires a reduced number of keys, which causes a problem that the number of different characters which may be entered into the machine is limited. Further, keyboard operation is, in general, burdensome to everyone, and it is difficult for inexperienced users to enter characters into the machine using the keyboard.

The present invention has been developed in view of the circumstances described above, and it is an object of the present invention to provide a system and method that allows everyone to readily enter desired character into a machine with a limited character entry capability, such as a shop front printing service machine and the like.

### SUMMARY OF THE INVENTION

A character entry system of the present invention comprises:

a portable terminal capable of transmitting a character entered therein; and

a first apparatus with a limited character entry capability that includes a communication means for receiving the character transmitted from the portable terminal and accepting entry of the character.

The referent of “limited character entry capability” as used herein means that the user is not just unable to enter characters but also able to enter characters using the touch panel or key board described above.

In the character entry system of the present invention, a configuration may be adopted wherein:

the first apparatus further includes a notification means for notifying identification information that identifies the first apparatus; and

the system further includes a second apparatus for proxying entry of a character that includes a communication means for receiving a character transmitted from the portable terminal and the identification information, and transmitting the received character to the first apparatus identified by the identification information.

Further, in the character entry system of the present invention, the first apparatus may further include a character attaching means for attaching the received character to an image.

An apparatus with a limited character entry capability according to the present invention includes a communication means for receiving a character transmitted from a portable terminal and accepting entry of the character.

The apparatus with a limited character entry capability according the present invention may further include a notification means for notifying self identification information.

The apparatus with a limited character entry capability according the present invention may further include a character attaching means for attaching the received character to an image.

A character entry proxy apparatus of the present invention is an apparatus for proxying entry of a character from a plurality of portable terminals, the apparatus comprising a communication means for receiving a character transmitted from the portable terminals and identification information that identifies an apparatus to which the character is to be transmitted, and transmitting the received character to the apparatus identified by the identification information.

A character entry method according to the present invention is a method for entering a character into an apparatus with a limited character entry capability, the method comprising the step of receiving a character transmitted from a portable terminal and accepting entry of the character.

A character entry proxying method according to the present invention is a method for proxying entry of a character from a plurality of portable terminals, the method comprising the steps of:

receiving a character transmitted from the portable terminals and identification information that identifies an apparatus to which the character is to be transmitted; and

transmitting the received character to the apparatus identified by the identification information.

The character entry method and character entry proxying method of the present invention may be provided in the form of a program to be executed by a computer.

According to the present invention, a character entered into a portable terminal is transmitted to a first apparatus with a limited character entry capability. Then, the character is received by the first apparatus and entry of the character is accepted. Here, the portable terminals such as cell phones and the like, which are currently in widespread use, have a superior character entry means with many keys and an efficient kana-kanji conversion capability. In particular, further use of the kana-kanji conversion capability by the user results in the conversion capability to become more efficient conversion tool for the user. According to the present invention, characters are entered into the first apparatus with a limited character entry capability using a portable terminal, so that everyone may readily enter desired characters into the first apparatus, even if the character entry capability thereof is limited.

### BRIEF DESCRIPTION OF THE DRAWINGS

FIG. 1 is a conceptual diagram of a printing service ordering system that employs the character entry system according to an embodiment of the present invention.

FIG. 2 is a schematic block diagram of a shop front printing service machine, illustrating the construction thereof.

FIG. 3 is a schematic block diagram of a character entry server, illustrating the construction thereof.

FIG. 4 is a flowchart illustrating a process flow performed in the shop front printing service machine.

FIG. 5 is a flowchart illustrating a character entry acceptance process flow (part 1).

FIG. 6 is a flowchart illustrating a character entry acceptance process flow (part 2).

FIG. 7 is a drawing illustrating the contents of a request management table.

FIG. 8 is a drawing illustrating an example guide screen.

FIG. 9 is a flowchart illustrating the process flow performed between a cell phone and the character entry server.

FIG. 10 is a drawing illustrating an example ID entry page.

FIG. 11 is a drawing illustrating an example character entry page.

### DESCRIPTION OF THE PREFERRED EMBODIMENTS

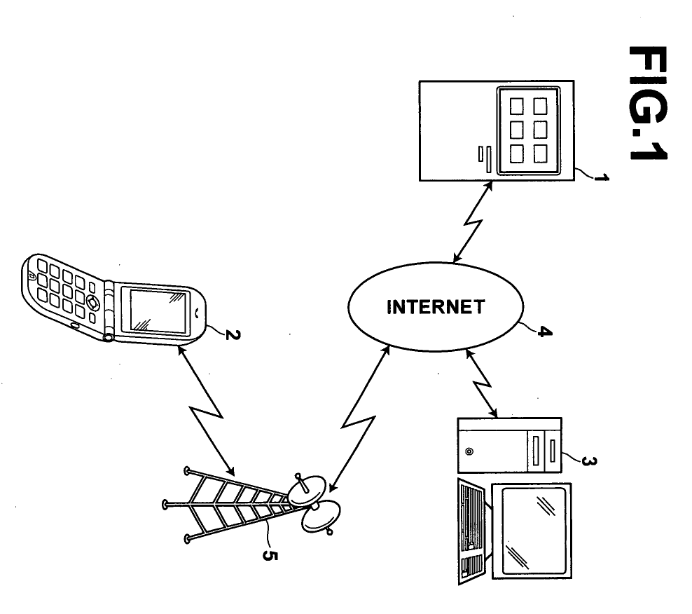

Hereinafter, embodiments of the present invention will be described with reference to the accompanying drawings. FIG. 1 is a conceptual diagram of a printing service ordering system that employs the character entry system according to an embodiment of the present invention. As shown in FIG. 1, the printing service ordering system that employs the character entry system according to the present embodiment includes a shop front printing service machine 1 installed at the front of a photo shop for accepting printing orders; a cell phone 2; and a character entry server 3 for proxying entry of a character to be described later, which transmit and receive data with each other via the Internet 4. The cell phone 2 is connected to the Internet 4 through a gateway 5.

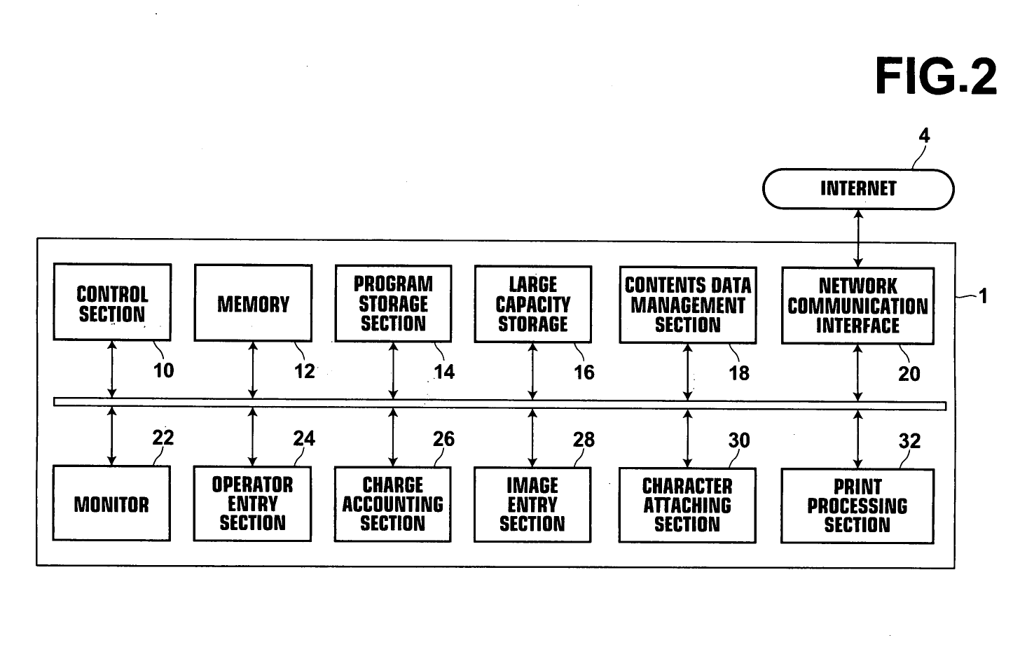

FIG. 2 is a schematic block diagram of the shop front printing service machine 1, illustrating the construction thereof. As shown in FIG. 2, the shop front printing service machine 1 includes: a control section 10, which is constituted by a CPU or the like, that provides overall control of the shop front printing service machine 1, including communication control, print control, display control, and the like; a memory 12 constituted by a RAM, which is a storage means that provides a working area for a program during execution; and a program storage section 14 for storing programs that operate in the control section 10, including a print processing program and a data transmission/reception program; a large capacity storage 16 constituted by a hard disk or the like for storing image data; a contents data management section 18 that manages contents data for displaying a guide screen for placing a printing order, and the like; and a network communication interface 20 for connecting the printing service machine 1 to the Internet 4.

The shop front printing service machine 1 further includes: a monitor 22 that displays various screens; an operator entry section 24 of a touch panel type; a charge accounting section 26 that performs a charge accounting process; an image entry section 28 having different type card slots for reading out image data from various memory cards; a character attaching section 30 for attaching entered characters to image data; and a print processing section 32 that performs printing process based on entries from the operator entry section 24.

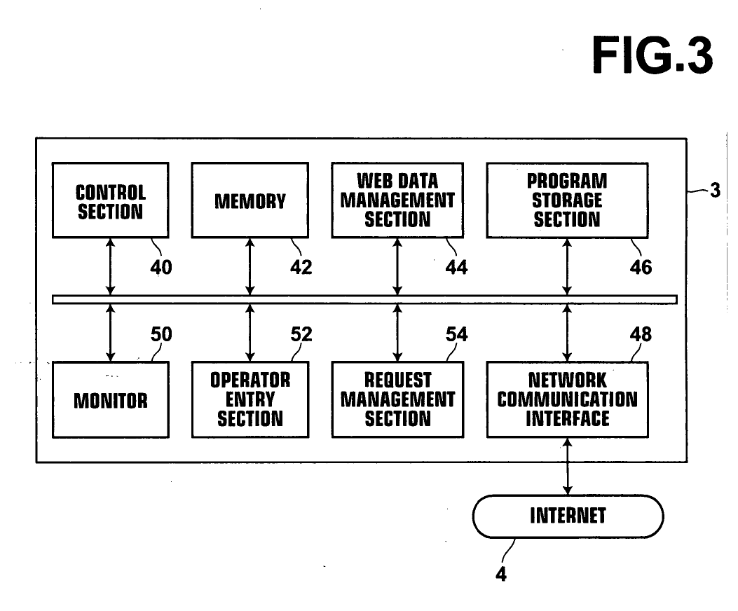

FIG. 3 is a schematic block diagram of a character entry server 3, illustrating the construction thereof. As shown in FIG. 3, the character entry server 3 includes: a control section 40 that provides overall control of the character entry server 3, including communication control, display control, and the like; a memory 42 constituted by a RAM, which is a storage means that provides a working area for a program during execution; a Web data management section 44 that manages Web data for displaying Web screens on the cell phone 2 for character entry when communicating therewith; a program storage section 46 for storing programs that operate in the control section 40, including a data transmission/reception program; and a network communication interface 48 for connecting the character entry server 3 to the Internet 4.

The character entry server 3 further includes: a monitor 50 that displays various screens; an operator entry section 52 including a keyboard, a mouse, and the like; and a request management section 54 that manages a request management table to be described later.

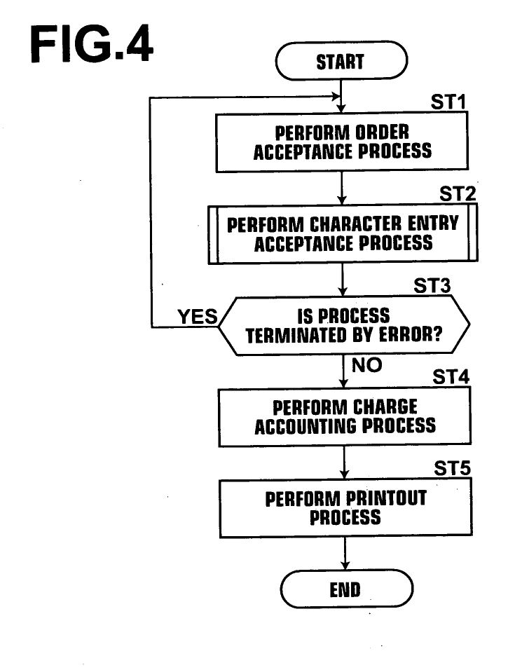

Hereinafter, the operation of the present embodiment will be described. FIG. 4 is a flowchart illustrating a process flow performed in the shop front printing service machine 1. When a printing order is placed by the user using the operator entry section 24, a printing order program is executed by the control section 10 and the process flow is initiated to perform an order acceptance process, including reading out of image data from a memory card using the image entry section 28, storage of the image data read out from the memory card to the large capacity storage 16, display of the image data on the monitor 22, acceptance of selected image to be printed using the operator entry section 24, and the like (step ST1). Then, the acceptance process is performed for accepting entry of characters for the title and user name of the image to be printed (step ST2).

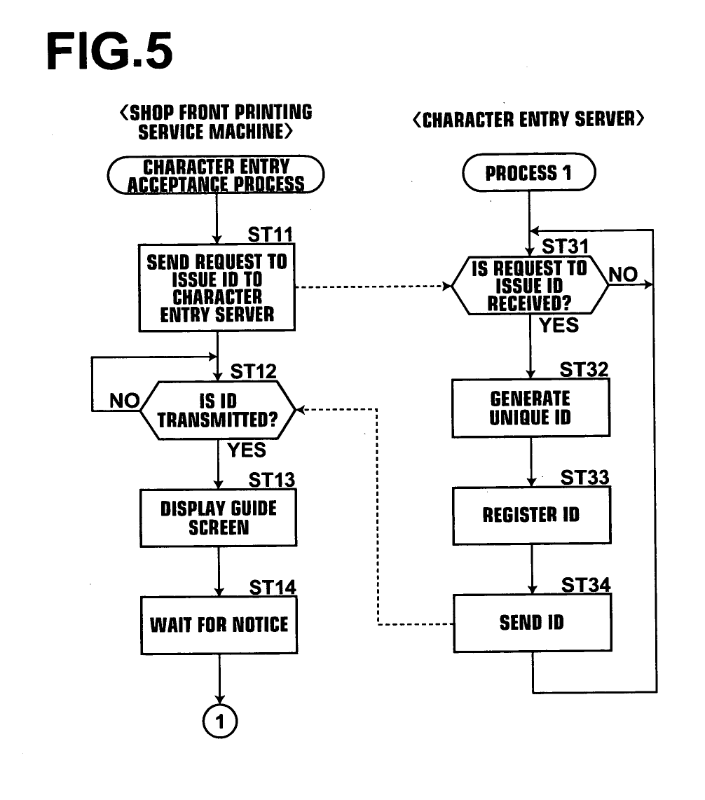

FIGS. 5 and 6 illustrate a flowchart of the character entry acceptance process. First, the shop front printing service machine 1 transmits to the character entry server 3 a request to issue an ID for identifying a character entered therein (step ST 11).

The character entry server 3 is continuously performing a process for issuing an ID (process 1), and monitoring whether there is a request to issue an ID (step ST31). Then, if the step ST31 is positive, it generates a unique ID (step ST32), and registers the generated ID and an ID that identifies the shop front printing service machine 1 to the request management table which is under control of the request management section 54 (step ST33). Thereafter, it transmits the generated ID to the requested shop front printing service machine 1 through the Internet 4, and returns to step ST31.

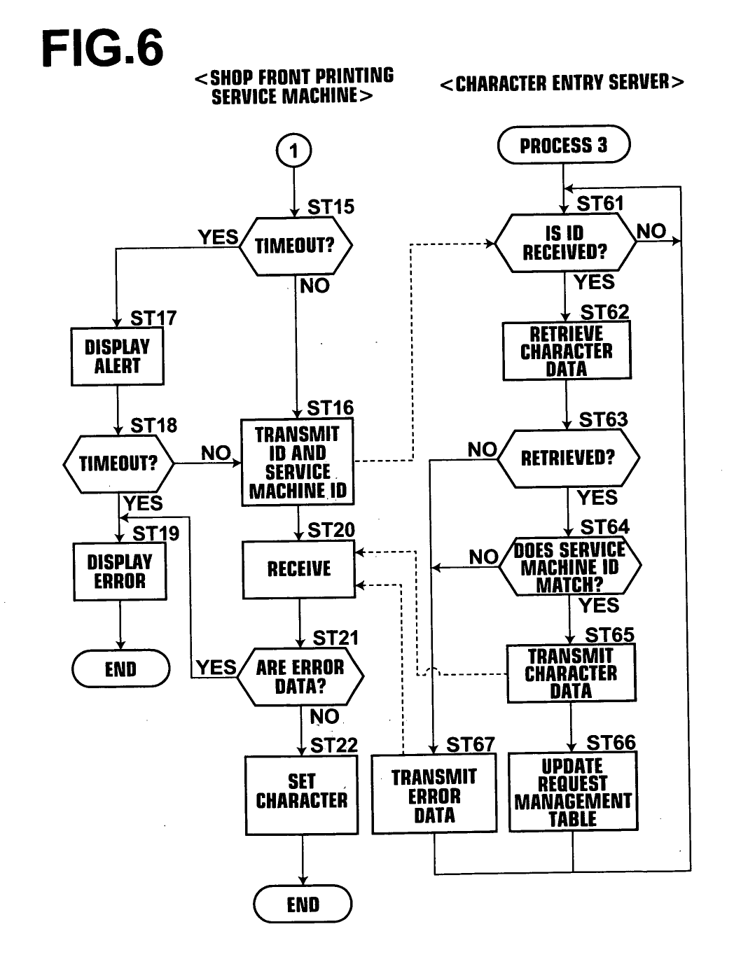

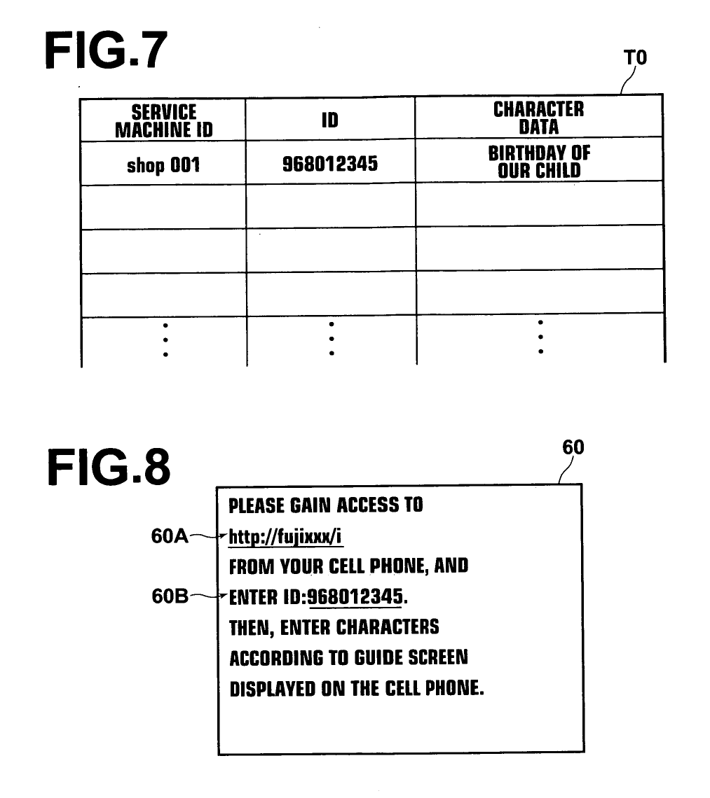

FIG. 7 is a drawing illustrating the request management table. As shown in FIG. 7, the request management table T0 includes the service machine ID (e.g., shop001), generated ID (e.g., 968012345), and character data (e.g., “birthday of Our Child”).

The shop front printing service machine 1 monitors whether the ID is sent from the character entry server 3 (step ST12), and if the step ST12 is positive, it displays a guide screen for guiding the URL of the character entry server 3 and ID on the monitor 22 (step ST13). Thereafter, it enters into a wait state until a notice of character entry completion is received from the character entry server 3 (step ST 14).

FIG. 8 is a drawing illustrating an example guide screen. As shown in FIG. 8, the guide screen 60 displays URL 60A of the character entry server 3 and ID 60B received. The user may gain access to the character entry server 3 by entering URL 60A displayed on the guide screen 60 of the cell phone 2.

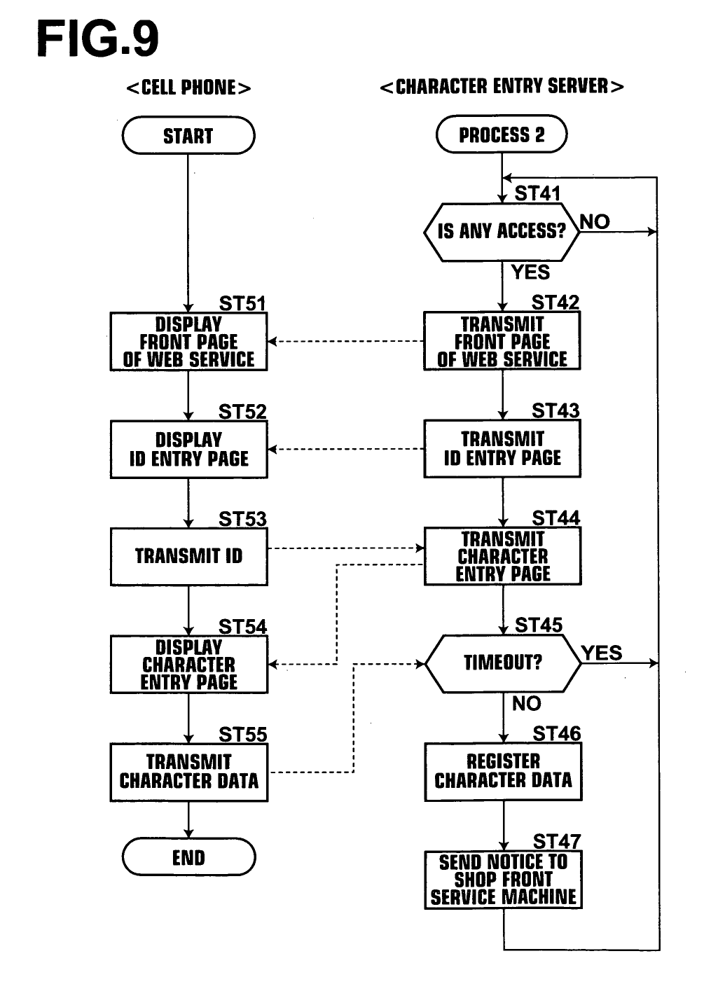

FIG. 9 is a flow chart illustrating the process flow performed between the cell phone 2 and the character entry server 3. The character entry server 3 is continuously performing a process for accepting entry of a character (process 2), and monitoring if the URL displayed on the guide screen 60 is accessed by the user using the cell phone 2 (step ST41). If the step ST41 is positive, it transmits the front page of the character entry web service to the cell phone 2 (step ST42). The cell phone 2 displays the front page (step ST51). Then, the character entry server 3 transmits an ID entry page to the cell phone 2 (step ST43), and the cell phone 2 displays the ID entry page (step ST52).

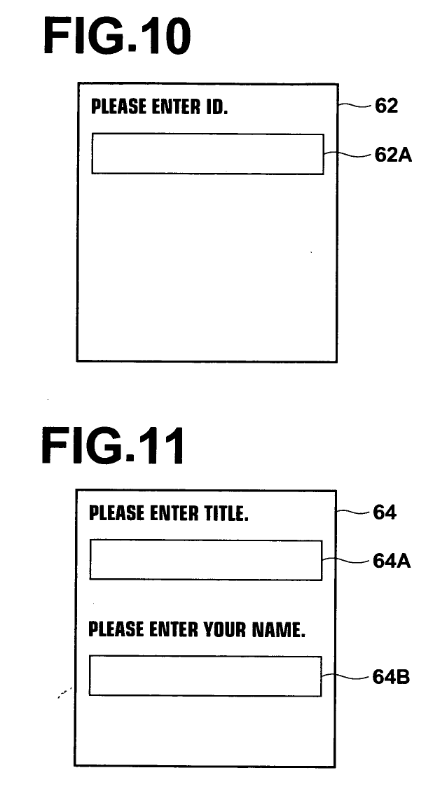

FIG. 10 is a drawing illustrating an example ID entry page. As shown in FIG. 10, the ID entry page 62 displays entry area 62A for entering the ID. The user enters the ID displayed on the guide screen 60 into the entry area 62A and transmits it to the character entry server 3(step ST53).

After receiving the ID, the character entry server 3 transmits a character entry page for entering characters to the cell phone 2 (step ST44), and the cell phone 2 displays the character entry page (step ST54).

FIG. 11 is a drawing illustrating an example character entry page. As shown in FIG. 11, the character entry page 64 displays a title area 64A for entering a title to be attached to the image, and a name entry area 64B for entering the name of the user. The user enters a title to be attached to the image into the title area and the user name into the name entry area respectively, and transmits character data representing the entered characters to the character entry server 3 (step ST55), and terminates.

The character entry server 3 monitors a timeout, i.e., whether a predetermined time has elapsed from the step ST44 (step ST45), and when characters are received within the predetermined time period (step ST45 is negative), it registers the received character data to the request management table with the entered ID associated therewith (step ST46). Further, it sends a notice of character entry completion to the shop front printing service machine 1 (step ST47), and returns to the step ST41. If the step ST45 is positive, the character entry server 3 returns to the step ST41 as well.

The shop front printing service machine 1 monitors a timeout, i.e., whether a predetermined time has elapsed from the step ST14 (step ST15). If the notice is received from the character entry server 3 within a predetermined time period (step ST15 is negative), it transmits the ID and service machine ID to the character entry server 3 (step ST16). On the other hand, if the notice is not received from the character entry server 3 within the predetermined time period (step ST15 is positive), it displays an alert on the monitor 22 (step ST17). If the notice is not received from the character entry server 3 within another predetermined time period (step ST18 is positive), it displays an error and terminates (step ST19). On the other hand, if the notice is received from the character entry server 3 within the predetermined time period (step ST 18 is negative), it transmits the ID and service machine ID to the character entry server 3 (step ST16)

The character entry server 3 is continuously performing a process for transmitting character data (process 3), and monitoring whether the ID is received from the shop front printing service machine 1 (step ST61). If step ST61 is positive, it retrieves character data corresponding to the received ID from the request management table T0 (step ST62). Then, it determines if the character data corresponding to the received ID is retrieved (step ST63). If the step ST63 is positive, it further determines if the service machine ID matches (step ST64). If the step ST64 is positive, it transmits the retrieved character data to the shop front printing service machine 1 (step ST65). It further updates the request management table T0 by deleting the transmitted character data, ID and service machine ID corresponding to the transmitted character data therefrom (step ST66), and returns to step ST61.

In the mean time, if both steps ST63 and ST64 are negative, the character entry server 3 transmits error data to the shop front printing service machine 1 (step ST67), and returns to step ST61.

The shop front printing service machine 1 receives the data transmitted from the character entry server 3 (step ST20), and determines if the received data are error data (step ST21). If the step ST21 is positive, it moves to the step ST19 to display the error data, and terminates.

If the step ST21 is negative, it attaches the title represented by the character data received by the character attaching section 30 to the corresponding image, sets the name of the user in the user name (character setting in step ST22), and terminates the character entry acceptance process flow.

Now returning to FIG. 4, following the step ST2, the shop front printing service machine 1 determines if the character entry acceptance process flow is terminated because of an error (step ST3), and if the step ST3 is positive, it returns to step ST1. If the step ST3 is negative, the charge accounting process for the printing order is performed by the charge accounting section 26 (step ST4), and the printout process is performed by the print processing section 32 (ST5). Then, the process flow of the shop front printing service machine 1 is terminated.

Here, the cell phone 2 which is currently used widely has a superior character entry means with many keys and an efficient kana-kanji conversion capability. In particular, further use of the kana-kanji conversion capability by the user results in the conversion capability to become more efficient conversion tool for the user. In the present embodiment, characters for the image title and name of the user are entered into the shop front printing service machine 1 using the cell phone 2, so that everyone may readily enter desired characters into the shop front printing service machine 1, even if the character entry capability thereof is limited.

In the present embodiment, the shop front printing service machine 1 may include a character entry means that employs a touch panel or a keyboard. This allows the user to enter characters in the shop front printing service machine 1 without a cell phone 2.

Further, in the present embodiment, the ID is issued by the character entry server 3. But a configuration may be adopted in which the ID is issued by the shop front printing service machine 1, and transmitted to the character entry server 3. In this case, the character entry server 3 registers the received ID to the request management table. If the ID is issued by the shop front printing service machine 1, it is preferable that an ID combined with the service machine ID is issued in order not to be duplicated with the ID issued by another shop front printing service machine 1.

Still further, in the present embodiment, the characters are transmitted from the cell phone 2 to the shop front printing service machine 1 via the character entry server 3. But a configuration may be adopted in which character data are directly transmitted from the cell phone 2 to the shop front printing service machine 1 using, for example, infrared communication or the like. In this case, an application for entering characters and transmitting character data representing the characters entered therein to the shop front printing service machine 1 is installed in the cell phone 2. The user of the cell phone 2 transmits the character data to the shop front printing service machine 1 using this application.

Further, in the present embodiment, the character entry system of the present invention is applied to a printing order system. But the application of the character entry system is not limited to this, and it may also be used, for example, when entering characters for a program title and the like in a home DVD recorder. In this case, the DVD recorder communicates with the character entry server 3 to display the ID on the TV screen connected to the DVD recorder, and the ID and character data representing the title are transmitted to the character entry server 3 from the cell phone 2 by the user. Then, the character data are transmitted from the character entry server 3 to the DVD recorder, and characters represented by the character data received by the DVD recorder are attached as the program title by the DVD recorder.

What is claimed is:

1. A character entry system, comprising:
a portable terminal capable of transmitting a character entered therein; and
a first apparatus with a limited character entry capability that includes a communication means for receiving the character transmitted from the portable terminal and accepting entry of the character.

2. The character entry system according to claim 1, wherein:
the first apparatus further includes a notification means for notifying identification information that identifies the first apparatus; and
the system further includes a second apparatus for proxying entry of a character that includes a communication means for receiving a character transmitted from the portable terminal and the identification information, and transmitting the received character to the first apparatus identified by the identification information.

3. The character entry system according to claim 1, wherein the first apparatus further includes a character attaching means for attaching the received character to an image.

4. An apparatus with a limited character entry capability, comprising a communication means for receiving a character transmitted from a portable terminal and accepting entry of the character.

5. The apparatus according to claim 4, further comprising a notification means for notifying self identification information.

6. The apparatus according to claim 4 or 5, further comprising a character attaching means for attaching the received character to an image.

7. A character entry proxy apparatus for proxying entry of a character from a plurality of portable terminals, the apparatus comprising a communication means for receiving a character transmitted from the portable terminals and identification information that identifies an apparatus to which the character is to be transmitted, and transmitting the received character to the apparatus identified by the identification information.

8. A character entry method for entering a character into an apparatus with a limited character entry capability, the method comprising the step of receiving a character transmitted from a portable terminal and accepting entry of the character.

9. A character entry proxying method for proxying entry of a character from a plurality of portable terminals, the method comprising the steps of:
receiving a character transmitted from the portable terminals and identification information that identifies an apparatus to which the character is to be transmitted; and
transmitting the received character to the apparatus identified by the identification information.

10. A program for causing a computer to execute a character entry method for use with an apparatus with a limited character entry capability, the method comprising the step of receiving a character transmitted from a portable terminal and accepting entry of the character.

11. A program for causing a computer to execute a method for proxying entry of a character from a plurality of portable terminals, the method comprising the steps of:
receiving a character transmitted from the portable terminals and identification information that identifies an apparatus to which the character is to be transmitted; and
transmitting the received character to the apparatus identified by the identification information.
